(19) United States
(12) Patent Application Publication
(10) Pub. No.: US 2009/0094270 A1
(43) Pub. Date: Apr. 9, 2009

(54) METHOD OF BUILDING A VALIDATION DATABASE

(76) Inventors: Baldomero J. Alirez, Austin, TX (US); Patricia M. Bluhm, Austin, TX (US); Jackie J. Hartman, Georgetown, TX (US)

Correspondence Address: MICHELLE A. ZARINELLI;C/O WEST CORPORATION, 11808 MIRACLE HILLS DR., MAIL STOP: W11-LEGAL, OMAHA, NE, 68154, US

(21) Appl. No.: 11/868,792

(22) Filed: Oct. 8, 2007

(51) Int. Cl. G06F 17/30

(52) U.S. Cl. 707/102; 707/E17.005

(57) ABSTRACT

A validation database (VDB) is built from geographic reference data sources such as MSAG and USPS using automatic address correlation, and links between the records are stored in the VDB. The automatic address correlation employs multiple correlation algorithms, and a score is assigned to each link representing a confidence level. The score is based on a combination of results from the different algorithms. Links having a score representing a partial or exact match are used for address validation purposes. A management interface allows the VDB agent to edit master records and the links, including the score. A remote subscriber can request validation of a proposed address from the VDB, and may include match criteria with the request. If any matches are found, a validation reply is sent from the VDB to the subscriber with the corresponding MSAG records.

### BACKGROUND OF THE INVENTION

1. Field of the Invention

The present invention generally relates to a method and system for building a database used to validate geographic locations (addresses), particularly as part of an enhanced 9-1-1 emergency services response system which automatically provides an address of a calling party.

2. Description of the Related Art

Someone involved in an emergency situation can place a telephone call to a special number in order to obtain emergency response services such as an ambulance, police or fire truck. In North America callers dial 9-1-1 for such emergency response services; in Europe callers dial 1-1-2. It is important for the emergency response services provider to be able to immediately identify the location of the caller in order to quickly move the appropriate emergency response equipment and personnel to that vicinity. While a caller can sometimes verbally provide this information, he or she may not know the exact location, may be incapacitated or restrained, or may be panicked or otherwise incapable of providing the location. The caller may also mistakenly provide an incorrect location.

Early 9-1-1 call routing systems did not provide any information regarding the geographic location of the caller, and relied on the public safety answering point (PSAP) operator to discern the location. Oftentimes it was necessary to manually forward the call to a different PSAP. To remedy these flaws in emergency response, the Wireless Communications and Public Safety Act of 1999 mandated an enhanced call routing system (E-9-1-1) that reliably associates a physical address with the calling party. The E-9-1-1 requirements consist of three major features: selective routing, automatic number identification (ANI), and automatic location identification (ALI). Telephone systems have long been capable of transmitting the caller's phone number for billing purposes and for caller identification, and this feature is used to enable ANI. The caller's number is then used as the basis for selective routing and ALI.

FIG. 1 shows a simplified example of an E-9-1-1 call routing system 10. When a new customer telephone 12 is installed, the telephone company (voice service provider) enters an address for the telephone number into a Master Street Address Guide (MSAG) 14. MSAG 14 is traditionally maintained privately by the telephone company. An MSAG entry has a street name, direction prefix (e.g., “NW”), suffix (e.g., “Lane”), direction suffix, address range, and PSAP identifier. The information in MSAG 14 eventually propagates to an ALI database 16, which may take up to 72 hours. ALI database 16 maintains associated records for the telephone number, location, and PSAP identifier. Thereafter, when the caller at telephone 12 makes a 9-1-1 call, it is intercepted by a selective router 18 which also receives the calling party's telephone number via ANI. Selective router 18 sends a query to ALI database 16 with the caller's telephone number. ALI database 16 responds by sending the identifier for the PSAP 20 associated with that telephone number back to selective router 18. Selective router 18 then forwards the call (voice) along with the phone number to the PSAP uniquely indicated by the identifier. PSAP 20 issues a further query to ALI database 16 with the calling number, and ALI database 16 returns the address associated with the calling number. In this manner the operator at the correct answering point, that is the one which serves the calling party's area, is automatically provided with the location of the caller.

The basic scheme illustrated in FIG. 1 has been modified to accommodate other telecommunications technologies such as voice over internet protocol (VoIP) calling. A VoIP enterprise may not have access to an MSAG, and so may use alternative geographic reference data sources (national, regional, or local) such as United States Postal Service (USPS) records. These records may for example be carrier route information system (CRIS) files available on a monthly subscription basis, and are similar to MSAG records but lack any PSAP identifiers. A VoIP E-9-1-1 system uses a positioning center service to identify the appropriate PSAP. This VoIP positioning center (VPC) may use an alias phone number for mobile telephone users to associate the call with the correct PSAP. The VPC provides the real address for the aliased number to an ALI database which then forwards the address to the PSAP.

It is critical to these processes that the location records, e.g., addresses or community names, are “valid” civic or postal designations known by the emergency services provider at the PSAP. However, the MSAG records often do not correspond with local address jargon. A subscriber-provided address may be erroneous, incomplete, a nickname or alias, or a slight variation of an MSAG location. There is accordingly a need to provide validation services for addresses which are to be used with ALI. The National Emergency Number Association (NENA) has published an Interim VoIP architecture for E-9-1-1 services which relies on a validation database for this purpose. The validation database (VDB) performs MSAG validation of a civic address request before service is turned on. This process merely ensures that the address is a real address (i.e., the address exists) but does not ensure that it is in actuality the location of the caller.

When new customers sign up for telephone service, they and their voice service providers want to have the new numbers operational as quickly as possible. However, this process is sometimes delayed for days if the customer-provided address does not match the MSAG. For some enterprises up to 45% of subscriber records have address issues that need to be researched and corrected. Many of these errors are simple civic address inconsistencies which can take days to resolve after manual intervention. It would, therefore, be desirable to provide a system for accurate address validation on-the-fly that could accept an address in a form received by the subscriber and translate it into a valid civic address that corresponds to a legitimate MSAG address. Where this cannot be accomplished, it would be further advantageous if the system could provide the subscriber with other options for validating a new customer location.

### SUMMARY OF THE INVENTION

It is therefore one object of the present invention to provide an improved method for building a validation database.

It is another object of the present invention to provide an intuitive management interface for such a validation database which allows easy and quick correction of location records.

It is yet another object of the present invention to provide a validation database and request protocol that can provide multiple suggestions for possible valid matches of a new service location.

The foregoing objects are achieved in an automated method for building a validation database, by receiving location records from a plurality of geographic reference data sources, correlating first location records from a first one of the geographic reference data sources with second location records from a second one of the geographic reference data sources, establishing links to associate the first location records with the second location records, and storing the first location records and the second location records with associated links in the validation database. The first and second location records may include both community records and street records, and the links may include community links for the community records and street links for the street records. In the preferred embodiment a score is assigned to each link representing a correlation confidence level. The correlation may be carried out using multiple (independent) algorithms, and the score is based on a combination of results from the different algorithms. A link is considered valid only if it has a score representing an exact match for one of the first location records with one of the second location records.

The above as well as additional objectives, features, and advantages of the present invention will become apparent in the following detailed written description.

### BRIEF DESCRIPTION OF THE DRAWINGS

The present invention may be better understood, and its numerous objects, features, and advantages made apparent to those skilled in the art by referencing the accompanying drawings.

FIG. 1 is a pictorial representation of a basic conventional implementation for enhanced 9-1-1 call location;

FIG. 2 is a block diagram of a system for building a validation database in accordance with one implementation of the present invention;

FIG. 3 is a one embodiment of a computer system that may be used to carry out various automated methods in accordance with the present invention;

FIG. 4 is a flow chart illustrating a procedure for correlating records from multiple geographic reference data sources in accordance with one implementation of the present invention;

FIG. 5 is a block diagram illustrating tables that comprise a validation database in accordance with one embodiment of the present invention;

FIGS. 6A and 6B are representations of community and street records in the validation database of FIG. 5;

FIG. 7 is a flow chart for managing community validation in accordance with one implementation of the present invention;

FIG. 8 is a flow chart for managing street validation in accordance with one implementation of the present invention;

FIG. 9 is a screen shot from the display of the computer system of FIG. 3, depicting a user interface for management of community validation in accordance with one implementation of the present invention;

FIG. 10 is a screen shot from the display of the computer system of FIG. 3, depicting a user interface for management of street validation in accordance with one implementation of the present invention; and

FIG. 11 is a flow chart for an enhanced V7 communications protocol in accordance with one implementation of the present invention.

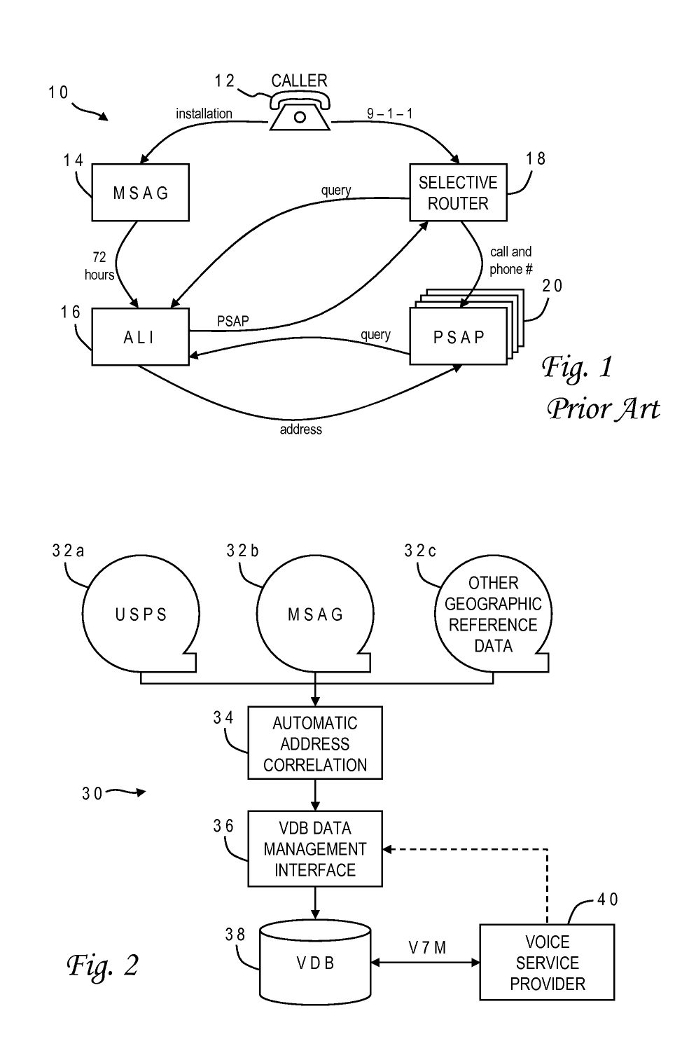

The use of the same reference symbols in different drawings indicates similar or identical items.

### DESCRIPTION OF THE PREFERRED EMBODIMENT(S)

With reference now to the figures, and in particular with reference to FIG. 2, there is depicted one embodiment 30 of a system for building a validation database (VDB) in accordance with the present invention. System 30 is generally comprised of a plurality of geographic reference data sources 32a, 32b, 32c, automatic address correlation logic 34, a VDB data management interface 36, and the VDB 38. In the illustrative embodiment, the geographic reference data sources include United States Postal Service (USPS) records 32a, and Master Street Address Guide (MSAG) records 32b. USPS records 32a may for example be USPS carrier route product or city state product files. MSAG records 32b may include multiple MSAG files. Other geographic reference data sources 32c may be used as will become apparent to one skilled in the art upon reference to this disclosure, including but not limited to private sources such as the map data files available from Tele Atlas NV or Navteq Corp.

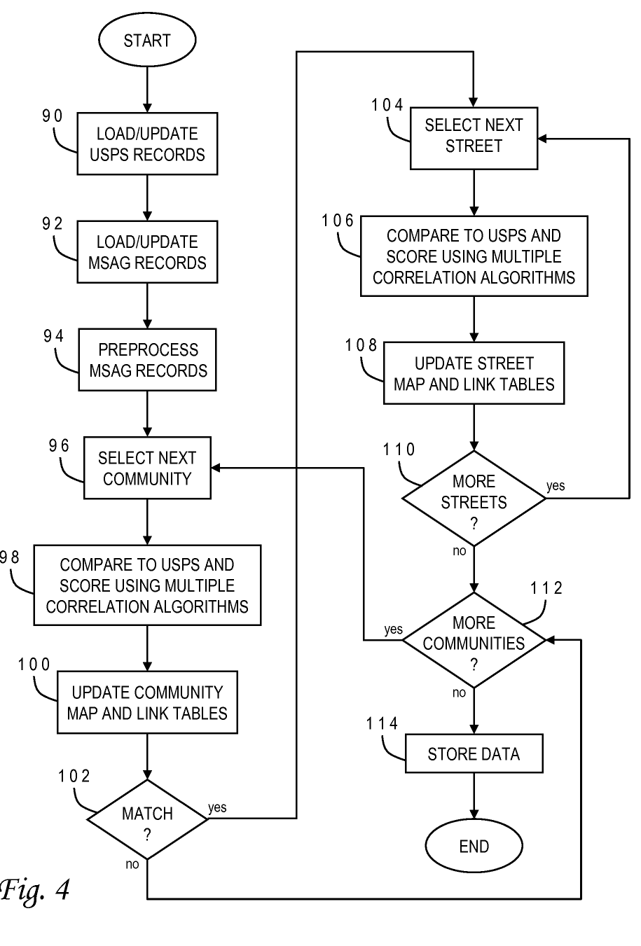

Automatic address correlation logic 34 merges the records from the geographic reference data sources 32 to build VDB 38, and inserts links to associate MSAG records with USPS records. In the preferred embodiment, each community or street comparison is assigned a score by automatic address correlation logic 34 reflecting the confidence level of the comparison. The multiple correlation algorithms and scoring methods used are discussed further below in conjunction with FIG. 4.

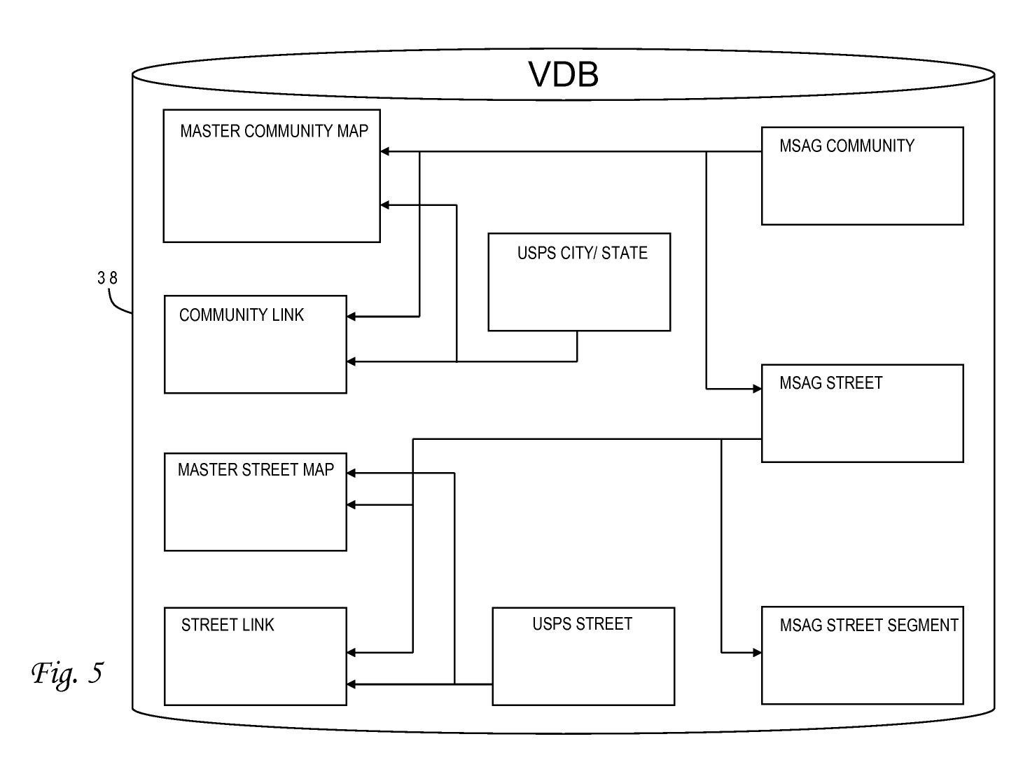

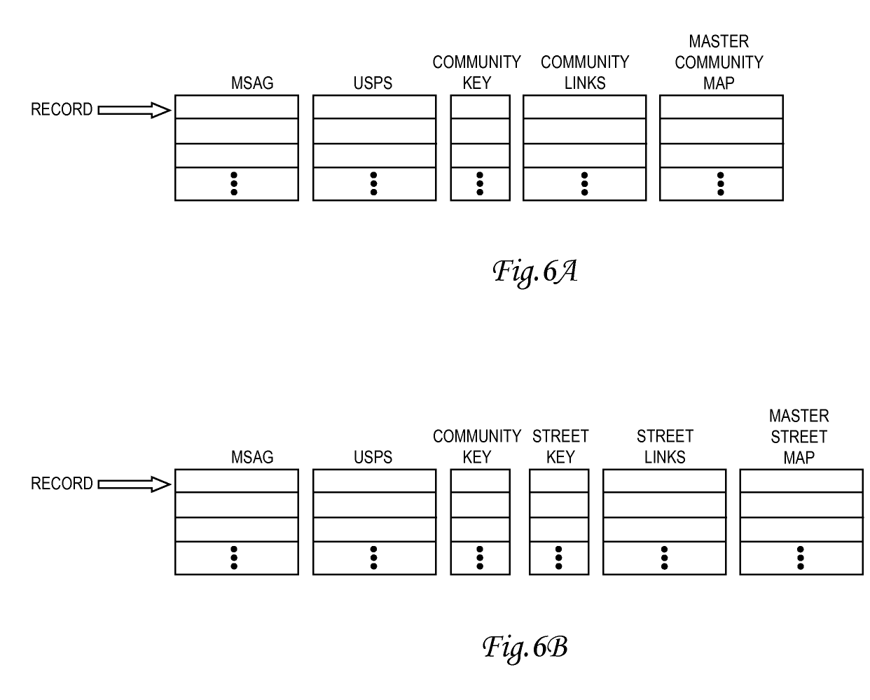

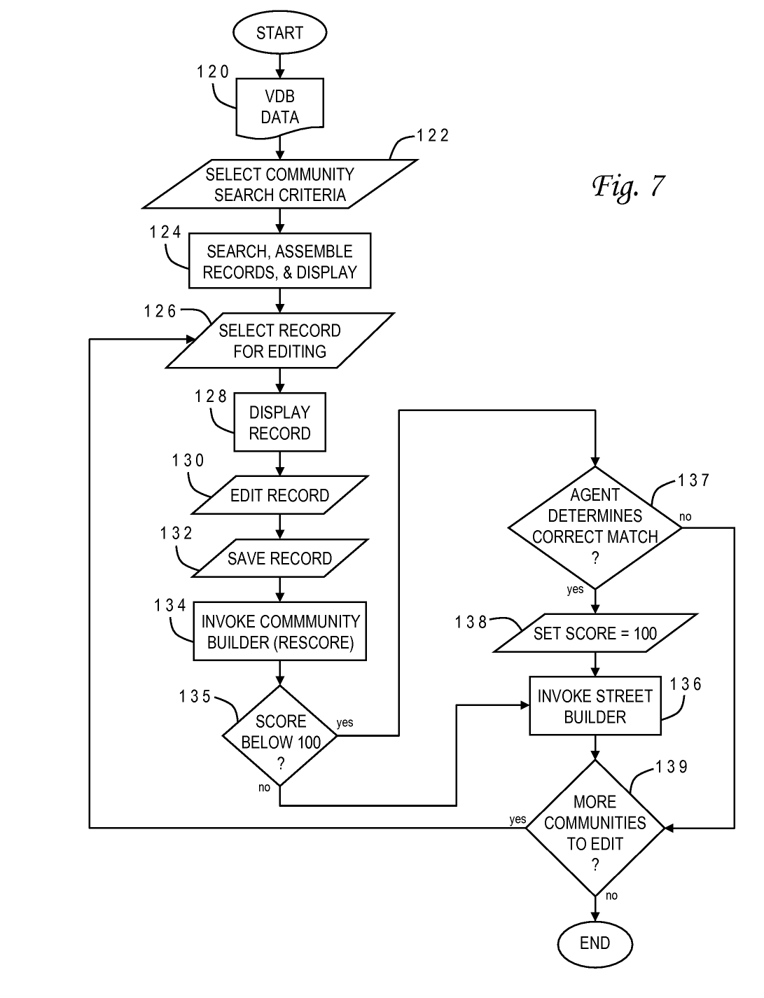

The fully automated processes of automatic address correlation logic 34 provide the initial data tables for the VDB, which are described in further detail in conjunction with FIGS. 5, 6A and 6B. This data may be manipulated using data management interface (DMI) 36. As explained below in conjunction with FIGS. 7-10, DMI 36 allows the VDB agent to search for community or street locations, particularly by score so that those MSAG records having less than a perfect score (100+) can be manually examined and edited as necessary. The resulting VDB 38 is then made available to a voice service provider 40 using a novel “V7M” communications protocol which is compliant with the National Emergency Number Association (NENA) “V7” protocol.

The V7M protocol allows subscriber 40 to send a proposed civic address to VDB 38 with an optional search level. If no matches are found within the search criteria, VDB 38 sends an error reply to subscriber 40. If any matches are found, VDB 38 sends the corresponding MSAG records and scores to subscriber 40. It is not necessary to have an exact match (score of 100 or more) for validation. Validation may be indicated as long as the requested address matches at least one MSAG address in the VDB. If there is no exact match, the subscriber can examine the suggested MSAG records to see if any of them clearly correspond to the desired address (e.g., the subscriber entered a misspelling of the street, or failed to include a street prefix or suffix). If the subscriber can identify the proper record, the validation process is repeated using the new location information. If there clearly is no appropriate match but the subscriber is sure that the civic address is correct, the location information can be forwarded to the VDB agent who can research the problem and build or modify link records using DMI 36. The V7M protocol is discussed further below in conjunction with FIG. 11.

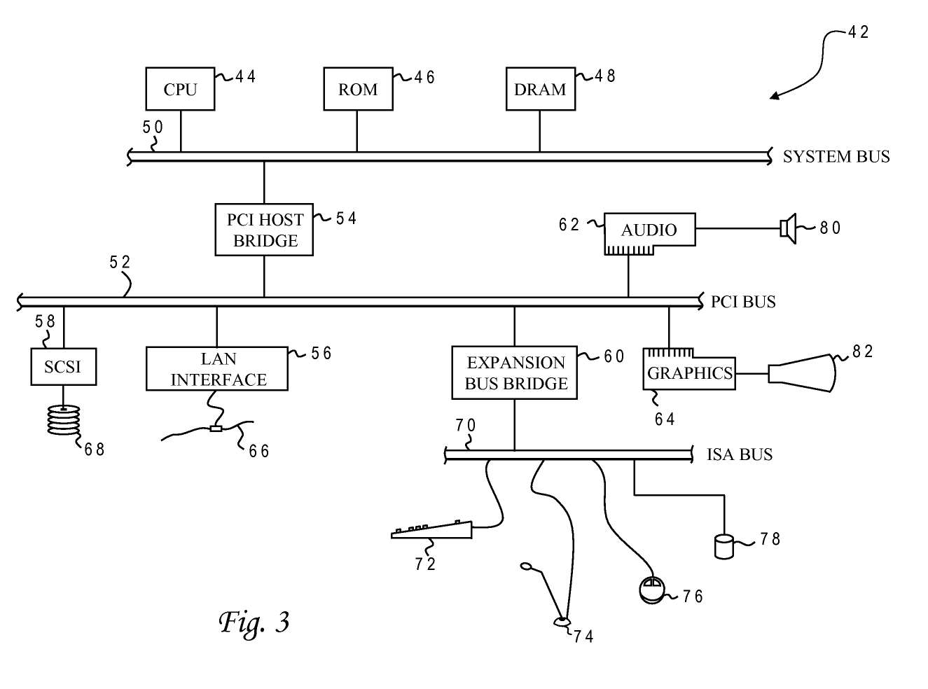

Referring now to FIG. 3, there is depicted one embodiment 42 of a computer system programmed to carry out validation database construction and management in accordance with one implementation of the present invention. System 42 includes a central processing unit (CPU) 44 which carries out program instructions, firmware or read-only memory (ROM) 46 which stores the system's basic input/output logic, and a dynamic random access memory (DRAM) 48 which temporarily stores program instructions and operand data used by CPU 44. CPU 44, ROM 46 and DRAM 48 are all connected to a system bus 50. There may be additional structures in the memory hierarchy which are not depicted, such as on-board (L1) and second-level (L2) caches. In high performance implementations, system 42 may include multiple CPUs and a distributed system memory.

CPU 44, ROM 46 and DRAM 48 are also coupled to a peripheral component interconnect (PCI) local bus 52 using a PCI host bridge 54. PCI host bridge 54 provides a low latency path through which processor 44 may access PCI devices mapped anywhere within bus memory or I/O address spaces. PCI host bridge 54 also provides a high bandwidth path to allow the PCI devices to access DRAM 48. Attached to PCI local bus 52 are a local area network (LAN) adapter 56, a small computer system interface (SCSI) adapter 58, an expansion bus bridge 60, an audio adapter 62, and a graphics adapter 64. LAN adapter 56 may be used to connect computer system 42 to an external computer network 66, such as the Internet. A small computer system interface (SCSI) adapter 58 is used to control high-speed SCSI disk drive 68. Disk drive 68 stores the program instructions and data in a more permanent state, including the program which embodies the present invention as explained further below, as well as any resultant data to be stored for later processing. Expansion bus bridge 60 is used to couple an industry standard architecture (ISA) expansion bus 70 to PCI local bus 52. As shown, several user input devices are connected to ISA bus 70, including a keyboard 72, a microphone 74, and a graphical pointing device (mouse) 76. Other devices may also be attached to ISA bus 70, such as a CD-ROM drive 78. Audio adapter 62 controls audio output to a speaker 80, and graphics adapter 64 controls visual output to a video monitor 82, to allow the user to build and edit the VDB as taught herein.

While the illustrative implementation provides the program instructions embodying the present invention on disk drive 68, those skilled in the art will appreciate that the invention can be embodied in a program product utilizing other computer-readable media, including transmission media.

Computer system 42 carries out program instructions for building a validation database using a novel technique wherein data records from multiple geographic reference sources are automatically linked with a confidence score for the link. Accordingly, a program embodying the invention may include conventional aspects of various database tools, and these details will become apparent to those skilled in the art upon reference to this disclosure. The program is preferably provided as extended markup language (XML) code that can be carried out using a web browser.

The present invention may be further understood with reference to the chart of FIG. 4 which illustrates the logical flow for building the VDB according to one implementation of the present invention. The procedure begins with the loading or updating of data from a first of the geographic reference sources, e.g., the USPS records (90). If no USPS data has previously been entered into the VDB, all data from the USPS records are copied into corresponding tables of the VDB. If the records are from a periodic update, only new records will be copied, i.e., the existing data is not overwritten. The USPS tables store house number, directional prefix, street name, street suffix, directional suffix, low block, high block, street side, city name, preferred city, county name, state/province code, postal/zip code, and country code.

The procedure continues with the loading or updating of data from a second of the geographic reference sources, e.g., the MSAG records (92). If no MSAG data has previously been entered into the VDB, all data from the MSAG records are copied into corresponding tables of the VDB. If the records are from a periodic update, only new records will be copied, i.e., the existing data is not overwritten, unless street data has changed in the record in which case that record is deleted and a new record inserted for the updated MSAG information. This step may be repeated for multiple MSAG files. The MSAG tables store directional prefix, street name, street suffix, directional suffix, low address range, high address range, odd/even indicator, community name, state, county identifier, emergency services number (ESN), public safety answering point identifier, general use information, and TAR code (TAR codes represent the taxing authority for a given subscriber which should correspond to its police, fire and rescue agencies, and are used by the telephone company to assign ESNs).

Once the USPS and MSAG records have been loaded, the MSAG records are preprocessed (94). This preprocessing includes record-by-record error checking, and sorting by community. The error checking may for example look for missing data fields, or a low block value that is greater than the high block value.

The procedure then invokes a master community builder which iteratively analyzes each MSAG community to find a matching USPS community, beginning alphabetically with the first MSAG community (96). The selected MSAG community is compared to the USPS community records using multiple correlation algorithms as necessary, and a score is generated reflecting the confidence level of the correlation (98). In the exemplary embodiment, there are five score categories whose symbols and meanings are set forth in Table 1:

TABLE 1

| Score Category | Symbol | Meaning |
|---|---|---|
| No Match | [symbol] (red) | Score is 0, no potential matches found |
| Warning | Δ (yellow) | Community or street score is between 1 |
| | | and 89 |
| Likely Match | [symbol] (blue) | Community or street score is between |
| | | 90 and 99 |
| Exact Match | ◯ (green) | Score is 100 or higher |
| MSAG Record | MSAG (green) | Record is exact copy of MSAG data |
| | | (score 200) or is parsed version (score |
| | | 201) and is informational only |

An exact match indicates the community data can be used during address validation for E-9-1-1 purposes. Any record having a score less than 100 should be manually verified for accuracy. Records are immediately available for use in validation even if the score is less than 100.

The correlation score is determined using a variety of algorithms. In the preferred implementation, the master community builder first attempts to find an exact match for the community name, county and state. If an MSAG record covers a county with no community specified, a lower score (less than 100) is assigned and street links are built for every community within the county. If a community name is provided but there is no exact match, the automated matching process attempts to find at least one match where the preferred city or city name in the USPS record is the same as the MSAG community. The preferred city or city name is probably correct but this record should preferably be verified by the agent. If none of these circumstances apply and there are matches for the county and state but no exact match for the community name, a fuzzy search is carried out on the community name. The fuzzy search looks at character patterns in the names to find similar words, i.e., misspelled words or typographical errors. Exemplary community scores based on this strategy are set forth in Table 2:

TABLE 2

| Score | Condition |
|---|---|
| 101 | The VDB automated process matched the MSAG community to a valid United States |
| | Postal Service (USPS) community on the community name, the county and the state. |
| 100 | A VDB agent manually verified and approved the USPS community, county and/or |
| | state to create a correlation. |
| 99 | The MSAG record covers a county, with no community specified. |
| | To verify, the agent leaves the community blank and specifies the county and state. |
| 90 | More than one match was found for a community between the USPS data and the |
| | MSAG data. |
| | The automated matching process found at least one match where the Preferred City in |
| | the USPS dataset equals the VDB MSAG Community. |
| | This is likely the correct Preferred City but it should be verified by an agent. |
| 80 | No exact match was found between the USPS data and the MSAG community. |
| | The VDB returned the first community where the city in the USPS data matched the |
| | MSAG community. |
| | The Preferred Community that was returned should be verified. |
| | Where the MSAG community and USPS community do match, the county may not be |
| | identified in the county translation table. |
| 60 | An exact match was found between the VDB data for county and state against the |
| | USPS data. |
| | A fuzzy match was found on the community name. |
| | A fuzzy match identifies a close match between the VDB and USPS communities. |
| 40 | A street crosses community boundaries within a single county. |
| | Records with this score must be confirmed and updated before they are considered by |
| | the validation logic. |
| 0 | No exact or fuzzy match was found between the USPS and VDB community data. |
| 200/ | MSAG Community Record |
| MSAG | (This score was automatically assigned when the MSAG record was imported into the |
| | VDB.) |

Once an MSAG community is scored, corresponding records are inserted into the master community map and link tables in the VDB (100). If the selected MSAG community can be linked to a USPS record with a score greater than zero (102), a master street builder is invoked which iteratively analyzes each MSAG street in the current community to find a matching USPS street, beginning alphanumerically with the first MSAG street (104). The selected MSAG street is compared to the USPS street records using multiple correlation algorithms as necessary, and a score is again generated reflecting the confidence level of the correlation (106). An exact match indicates the street data can be used during address validation for E-9-1-1 purposes. Any record having a score less than 100 should be manually verified for accuracy. Records are immediately available for use in validation even if the score is less than 100.

The score for street names may reflect a different set of correlation algorithms. In the preferred implementation, the master street builder first attempts to find an exact match for the street name, directional prefix, street suffix, and directional suffix. If no exact match is found, various permutations of partial matches for these four data fields can be searched, optionally ignoring any null fields in the directional prefix, directional suffix, or street suffix (“loose” searching). If a match is still not found, other search techniques may be employed such as fuzzy searching or regular expression searching which looks for partial matches of numeric characters in a street name. If no match is found using all of these techniques, the search can be repeated using a larger region, e.g., county instead of city. Exemplary street scores based on this strategy are set forth in Table 3:

TABLE 3

| Score | Condition |
|---|---|
| 110 | An exact match was found on the street name, the directional prefix, the street suffix, and the |
| | directional suffix. |
| 109 | An exact match was found on the street name, the directional prefix, and the street suffix. |
| | The MSAG data contains no directional suffix. |
| 108 | An exact match was found on the street name, the directional prefix, and the directional suffix. |
| | The MSAG data contains no street suffix. |
| 107 | An exact match was found on the street name and the directional prefix. |
| | The MSAG data contains no street suffix and no directional suffix. |
| 106 | An exact match was found on the street name, the street suffix, and the directional suffix. |
| | The MSAG data contains no directional prefix. |
| 105 | An exact match was found on the street name and the street suffix. |
| | The MSAG data contains no directional prefix and no directional suffix. |
| 104 | An exact match was found on the street name and the directional suffix. |
| | The MSAG data contains no directional prefix and no street suffix. |
| 103 | An exact match was found on the street name. |
| | The MSAG data contains no directional prefix, no street suffix, and no directional suffix. |
| 102 | An exact match was found on the street name, the directional suffix, and the street suffix. |
| | The MSAG data contains no directional suffix. |
| 101 | An exact match was found on the street name and the directional suffix. |
| | The MSAG data contains no street suffix and no directional suffix. |
| 100 | A match between USPS and MSAG street data was manually verified. |
| 99 | An exact match was found on the street name, the directional prefix, and the street suffix. |
| | Any MSAG directional suffix was accepted. |
| 98 | An exact match was found on the street name, the street suffix, and the directional prefix. |
| | Any MSAG directional prefix was accepted. |
| 97 | An exact match was found on the street name, the directional prefix, and the directional suffix. |
| | Any MSAG street suffix was accepted. |
| 96 | An exact match was found on the street name and the street suffix. |
| | Any MSAG directional prefix or directional suffix was accepted. |
| 95 | An exact match was found on the street name and the directional prefix. |
| | Any MSAG street suffix or directional suffix was accepted. |
| 94 | An exact match was found on the street name and the directional suffix. |
| | Any MSAG directional prefix or street suffix was accepted. |
| 93 | An exact match was found on the street name only. |
| | Any MSAG directional prefix, street suffix or directional suffix was accepted. |
| 89 | A fuzzy match was found on the street name. |
| | An exact match was found on the directional prefix, the street suffix, and the directional suffix. |
| 88 | A fuzzy match was found on the street name. |
| | An exact match was found on the directional prefix and the street suffix. |
| | The MSAG data contains no directional suffix. |
| 87 | A fuzzy match was found on the street name. |
| | An exact match was found on the directional prefix and the directional suffix. |
| | The MSAG data contains no street suffix. |
| 86 | A fuzzy match was found on the street name. |
| | An exact match was found on the directional prefix. |
| | The MSAG data contains no street suffix and no directional suffix. |
| 85 | A fuzzy match was found on the street name. |
| | An exact match was found on the street suffix and the directional suffix. |
| | The MSAG data contains no directional prefix. |
| 84 | A fuzzy match was found on the street name. |
| | An exact match was found on the street suffix. |
| | The MSAG data contains no directional prefix and no directional suffix. |
| 83 | A fuzzy match was found on the street name. |
| | An exact match was found on the directional suffix. |
| | The MSAG data contains no directional prefix and no street suffix. |
| 82 | A fuzzy match was found on the street name. |
| | The MSAG data contains no directional prefix, no street suffix, and no directional suffix. |
| 81 | A fuzzy match was found on the street name. |
| | An exact match was found the directional suffix and street suffix. |
| | The MSAG data contains no directional suffix. |
| 80 | A fuzzy match was found on the street name. |
| | An exact match was found on the directional suffix. |
| | The MSAG data contains no street suffix and no directional suffix. |
| 78 | A fuzzy match was found on the street. |
| | An exact match was found on the directional prefix and the street suffix. |
| | Any MSAG directional suffix was accepted. |
| 77 | A fuzzy match was found on the street. |
| | An exact match was found on the street suffix and the directional suffix. |
| | Any MSAG directional prefix was accepted. |
| 76 | A fuzzy match was found on the street. |
| | An exact match was found on the directional prefix and the directional suffix. |
| | Any MSAG street suffix was accepted. |
| 75 | A fuzzy match was found on the street. |
| | An exact match was found on the street suffix. |
| | Any MSAG directional prefix or directional suffix was accepted. |
| 74 | A fuzzy match was found on the street. |
| | An exact match was found on the directional prefix. |
| | Any MSAG street suffix or directional suffix was accepted. |
| 73 | A fuzzy match was found on the street. |
| | An exact match was found on the directional suffix. |
| | Any MSAG directional prefix or street suffix was accepted. |
| 72 | A fuzzy match was found on the street. |
| | Any directional prefix, street suffix or directional suffix was accepted. |
| 69 | No match was found on the street name but the street contains numbers that indicate a potential |
| | match. |
| | A match was found on the directional prefix, the street suffix, and the directional suffix. |
| 68 | No match was found on the street name but the street contains numbers that indicate a potential |
| | match. |
| | A match was found on the directional prefix and the street suffix. |
| | The MSAG data contains no directional suffix. |
| 67 | No match was found on the street name but the street contains numbers that indicate a potential |
| | match. |
| | A match was found on the directional prefix and the directional suffix. |
| | The MSAG data contains no street suffix. |
| 66 | No match was found on the street name but the street contains numbers that indicate a potential |
| | match. |
| | A match was found on the directional prefix. |
| | The MSAG data contains no street suffix and no directional suffix. |
| 65 | No match was found on the street name but the street contains numbers that indicate a potential |
| | match. |
| | A match was found on the street suffix and directional suffix. |
| | The MSAG data contains no directional prefix. |
| 64 | No match was found on the street name but the street contains numbers that indicate a potential |
| | match. |
| | A match was found on the street suffix. |
| | The MSAG data contains no directional prefix and no directional suffix. |
| 63 | No match was found on the street name but the street contains numbers that indicate a potential |
| | match. |
| | A match was found on the directional suffix. |
| | The MSAG data contains no directional prefix and no street suffix. |
| 62 | No match was found on the street name but the street contains numbers that indicate a potential |
| | match. |
| | The MSAG data contains no directional prefix, no street suffix, and no directional suffix. |
| 61 | No match was found on the street name but the street contains numbers that indicate a potential |
| | match. |
| | A match was found on the directional suffix and the street suffix. |
| | The MSAG data contains no directional suffix. |
| 60 | No match was found on the street name but the street contains numbers that indicate a potential |
| | match. |
| | A match was found on the directional suffix. |
| | The MSAG data contains no street suffix and no directional suffix. |
| 58 | No match was found on the street name but the street contains numbers that indicate a potential |
| | match. |
| | An exact match was found on the directional prefix and the street suffix. |
| | Any directional suffix was accepted. |
| 57 | No match was found on the street name but the street contains numbers that indicate a potential |
| | match. |
| | An exact match was found on the street suffix and the directional prefix. |
| | Any directional prefix was accepted. |
| 56 | No match was found on the street name but the street contains numbers that indicate a potential |
| | match. |
| | An exact match was found on the directional prefix and the directional suffix. |
| | Any street suffix was accepted. |
| 55 | No match was found on the street name but the street contains numbers that indicate a potential |
| | match. |
| | An exact match was found on the street suffix. |
| | Any directional prefix or directional suffix was accepted. |
| 54 | No match was found on the street name but the street contains numbers that indicate a potential |
| | match. |
| | An exact match was found on the directional prefix. |
| | Any street suffix or directional suffix was accepted. |
| 53 | No match was found on the street name but the street contains numbers that indicate a potential |
| | match. |
| | An exact match was found on the directional suffix. |
| | Any directional prefix or street suffix was accepted. |
| 52 | No match was found on the street name but the street contains numbers that indicate a potential |
| | match. |
| | Any directional prefix, street suffix, or directional suffix was accepted. |
| 49 | A potential match was found in another community within the same county and state. |
| | An exact match was found on the street name, the directional prefix, the street suffix, and the |
| | directional suffix. |
| 48 | A potential match was found in another community within the same county and state. |
| | An exact match was found on the street name, the directional prefix and street suffix. |
| | The MSAG data contains no directional suffix. |
| 47 | A potential match was found in another community within the same county and state. |
| | An exact match was found on the street name, the directional prefix and directional suffix. |
| | The MSAG data contains no street suffix. |
| 46 | A potential match was found in another community within the same county and state. |
| | An exact match was found on the street name and the directional prefix. |
| | The MSAG data contains no street suffix and no directional suffix. |
| 45 | A potential match was found in another community within the same county and state. |
| | An exact match was found on the street name, the street suffix, and the directional suffix. |
| | The MSAG data contains no directional prefix. |
| 44 | A potential match was found in another community within the same county and state. |
| | An exact match was found on the street name and the street suffix. |
| | The MSAG data contains no directional prefix and no directional suffix. |
| 43 | A potential match was found in another community within the same county and state. |
| | An exact match was found on the street name and the directional suffix. |
| | The MSAG data contains no directional prefix and no street suffix. |
| 42 | A potential match was found in another community within the same county and state. |
| | An exact match was found on the street name. |
| | The MSAG data contains no directional prefix, no street suffix, and no directional suffix. |
| 41 | A potential match was found in another community within the same county and state. |
| | An exact match was found on the street name, the directional suffix and the street suffix. |
| | The MSAG data contains no directional suffix. |
| 40 | A potential match was found in another community within the same county and state. |
| | An exact match was found on the street name and the directional suffix. |
| | The MSAG data contains no street suffix and no directional suffix. |
| 38 | A potential match was found in another community within the same county and state. |
| | An exact match was found on the street name, the directional prefix, and the street suffix. |
| | Any directional suffix was accepted. |
| 37 | A potential match was found in another community within the same county and state. |
| | An exact match was found on the street name, the street suffix, and the directional prefix. |
| | Any directional prefix was accepted. |
| 36 | A potential match was found in another community within the same county and state. |
| | An exact match was found on the street name, the directional prefix and the directional suffix. |
| | Any street suffix was accepted. |
| 35 | A potential match was found in another community within the same county and state. |
| | An exact match was found on the street name and the street suffix. |
| | Any directional prefix or directional suffix was accepted. |
| 34 | A potential match was found in another community within the same county and state. |
| | An exact match was found on the street name and the directional prefix. |
| | Any street suffix or directional suffix was accepted. |
| 33 | A potential match was found in another community within the same county and state. |
| | An exact match was found on the street name and the directional suffix. |
| | Any directional prefix or street suffix was accepted. |
| 32 | A potential match was found in another community within the same county and state. |
| | An exact match was found on the street name only. |
| | Any directional prefix, street suffix or directional suffix was accepted. |
| 29 | A potential match was found in another community within the same county and state. |
| | No match was found on the street name but the street contains numbers that indicate a potential |
| | match. |
| | A match was found on the directional prefix, street suffix, and directional suffix. |
| 28 | A potential match was found in another community within the same county and state. |
| | No match was found on the street name but the street contains numbers that indicate a potential |
| | match. |
| | A match was found on the directional prefix and the street suffix. |
| | The MSAG data contains no directional suffix. |
| 27 | A potential match was found in another community within the same county and state. |
| | No match was found on the street name but the street contains numbers that indicate a potential |
| | match. |
| | A match was found on the directional prefix and the directional suffix. |
| | The MSAG data contains no street suffix. |
| 26 | A potential match was found in another community within the same county and state. |
| | No match was found on the street name but the street contains numbers that indicate a potential |
| | match. |
| | A match was found on the directional prefix. |
| | The MSAG data contains no street suffix and no directional suffix. |
| 25 | A potential match was found in another community within the same county and state. |
| | No match was found on the street name but the street contains numbers that indicate a potential |
| | match. |
| | A match was found on the street suffix and the directional suffix. |
| | The MSAG data contains no directional prefix. |
| 24 | A potential match was found in another community within the same county and state. |
| | No match was found on the street name but the street contains numbers that indicate a potential |
| | match. |
| | A match was found on the street suffix. |
| | The MSAG data contains no directional prefix and no directional suffix. |
| 23 | A potential match was found in another community within the same county and state. |
| | No match was found on the street name but the street contains numbers that indicate a potential |
| | match. |
| | A match was found on the directional suffix. |
| | The MSAG data contains no directional prefix and no street suffix. |
| 22 | A potential match was found in another community within the same county and state. |
| | No match was found on the street name but the street contains numbers that indicate a potential |
| | match. |
| | The MSAG data contains no directional prefix, no street suffix, and no directional suffix |
| 21 | A potential match was found in another community within the same county and state. |
| | No match was found on the street name but the street contains numbers that indicate a potential |
| | match. |
| | A match was found on the directional suffix and street suffix. |
| | The MSAG data contains no directional suffix. |
| 20 | A potential match was found in another community within the same county and state. |
| | No match was found on the street name but the street contains numbers that indicate a potential |
| | match. |
| | A match was found on the directional suffix. |
| | The MSAG data contains no street suffix or directional suffix. |
| 18 | A potential match was found in another community within the same county and state. |
| | No match was found on the street name but the street contains numbers that indicate a potential |
| | match. |
| | A match was found on the directional prefix and the street suffix. |
| | Any directional suffix was accepted. |
| 17 | A potential match was found in another community within the same county and state. |
| | No match was found on the street name but the street contains numbers that indicate a potential |
| | match. |
| | A match was found on the street suffix and the directional prefix. |
| | Any directional prefix was accepted. |
| 16 | A potential match was found in another community within the same county and state. |
| | No match was found on the street name but the street contains numbers that indicate a potential |
| | match. |
| | A match was found on the directional prefix and the directional suffix. |
| | Any street suffix was accepted. |
| 15 | A potential match was found in another community within the same county and state. |
| | No match was found on the street name but the street contains numbers that indicate a potential |
| | match. |
| | A match was found on the street suffix. |
| | Any directional prefix or directional suffix was accepted. |
| 14 | A potential match was found in another community within the same county and state. |
| | No match was found on the street name but the street contains numbers that indicate a potential |
| | match. |
| | A match was found on the directional prefix. |
| | Any street suffix or directional suffix was accepted. |
| 13 | A potential match was found in another community within the same county and state. |
| | No match was found on the street name but the street contains numbers that indicate a potential |
| | match. |
| | A match was found on the directional suffix. |
| | Any directional prefix or street suffix was accepted. |
| 12 | A potential match was found in another community within the same county and state. |
| | No match was found on the street name but the street contains numbers that indicate a potential |
| | match. |
| | Any directional prefix, street suffix, or directional suffix was accepted. |
| 0 | No exact or fuzzy match could be made between the USPS and VDB street data. |
| 200 | MSAG Community Record |
| | (This score was automatically assigned when the MSAG record was imported into the VDB). |
| 201 | MSAG Street Record |
| | (This score was automatically generated by the MasterStreetMap insert trigger). |

Once an MSAG street is scored, corresponding records are inserted into the master street map and link tables in the VDB (108). If there are additional streets to be analyzed in the current community (110), the next street is selected and the process repeats at step 104. Once all of the streets in the current community have been processed, if there are additional communities to be analyzed (112), the next community is selected and the process repeats at step 96. If no USPS community is matched with a selected MSAG record (102), the streets in that community are not processed, i.e., the procedure skips to step 112. After all of the MSAG communities have been processed, the VDB tables are stored for later subscriber access (114).

While FIG. 4 illustrates only the use of USPS and MSAG records, those skilled in the art will appreciate that records from other geographic reference data sources may also be loaded and similarly processed for address validation.

With further reference to FIG. 5, one embodiment of VDB 38 is depicted which has a plurality of database tables, including an MSAG community table, an MSAG street table, an MSAG street segment table, a USPS city/state table, a USPS street table, a master community map table, a community link table, a master street map table, and a street link table. A given table contains multiple data fields as described above, including multiple address fields, community, county, state, zip code, various database keys, create and modify dates, initials of the user, and links with scores. The community “San Francisco” may for example have links to community names “SF,” “Oakland,” “Hayward,” and “Chinatown.” VDB 38 may include additional tables not shown, such as areas served by the VDB, abbreviation translations, community translations, county translations, street translations, street aliases, and change request actions.

Community and street records in VDB 38 are shown in the virtualized representations of FIGS. 6A and 6B. A given record (row) is comprised of datasets from fields in different database tables. A record for a community may have MSAG data, USPS data, a community key, community links, and master community data. A record for a street may have MSAG data, USPS data, a community key, a street key, street links, and master street data.

The VDB records can be viewed and manipulated using DMI 36. FIG. 7 illustrates the logical flow for managing community validation information in accordance with one implementation of the present invention. The process begins with the VDB data that results from the automated procedure of FIG. 4 (120), which may have been previously edited. The VDB agent selects search criteria to locate community records that may need correction or verification (122). The search criteria can include community name, county, etc., or can include a score range or category for the records. For example, the agent may wish to first analyze all community records having no match, so the search criteria would include a score of zero. Records that meet the search criteria are assembled and displayed (124). The agent then selects one of the displayed records for editing (126), and a dialog box or child window appears to display the contents of the selected record (128). The community record is edited, e.g., a misspelling corrected (130). If the agent believes the dataset for this record is now accurate, the agent saves the changes (132). Saving the changes invokes the community link builder which attempts to find a correlating USPS community, and rescores the match (134). If the new score is now an exact match (135), the procedure invokes the street link builder process to update the affected community (136). Where the agent determines that the correlation is correct (137) but the community link builder has rescored the record below 100, the agent may manually change the score to 100 and save the data (138), and the street link builder process is invoked (136). Thereafter, the DMI will display the community record as an exact match. If the agent wishes to edit more community records (139), the process repeats iteratively at step 126 (or at step 122 if a new community search is desired). Both the community and street builder processes can run in the background as other community records are edited.

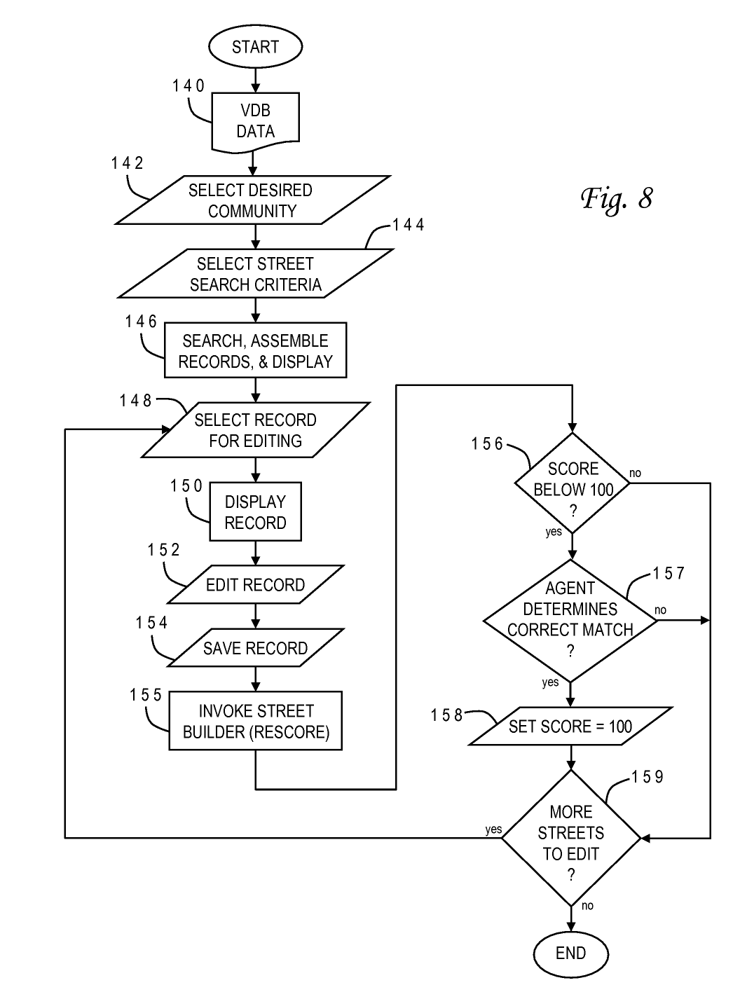

FIG. 8 illustrates the logical flow for managing street validation information in accordance with one implementation of the present invention. The process again begins with the VDB data that results from the automated procedure of FIG. 4 (140), which may have been previously edited. The VBD agent selects a community for review of street records in that community (142). The agent then selects search criteria to locate street records that may need correction or verification (144). The search criteria can include street name or a score range (category) for the records. For example, the agent may wish to first analyze all street records having no match, so the search criteria would include a score of zero. Records that meet the search criteria are assembled and displayed (146). The agent then selects one of the displayed records for editing (148), and a dialog box or child window appears to display the contents of the selected record (150). The street record is edited, e.g., a misspelling corrected (152). If the agent believes the dataset for this record is now accurate, the agent saves the changes (154). Saving the changes invokes the street link builder which attempts to find a correlating USPS street in the selected community, and rescores the match (155). If the new score is now an exact match (156), editing for this record is complete. Where the agent determines that the correlation is correct (157) but the street link builder has rescored the record below 100, the agent may manually change the score to 100 and save the data (158). Thereafter, the DMI will display the street record as an exact match. If the agent wishes to edit more street records (159), the process repeats iteratively at step 148 (or at step 144 if a new street search is desired, or at step 142 if searching streets in a different community is desired). The street builder process can run in the background as other street records are edited.

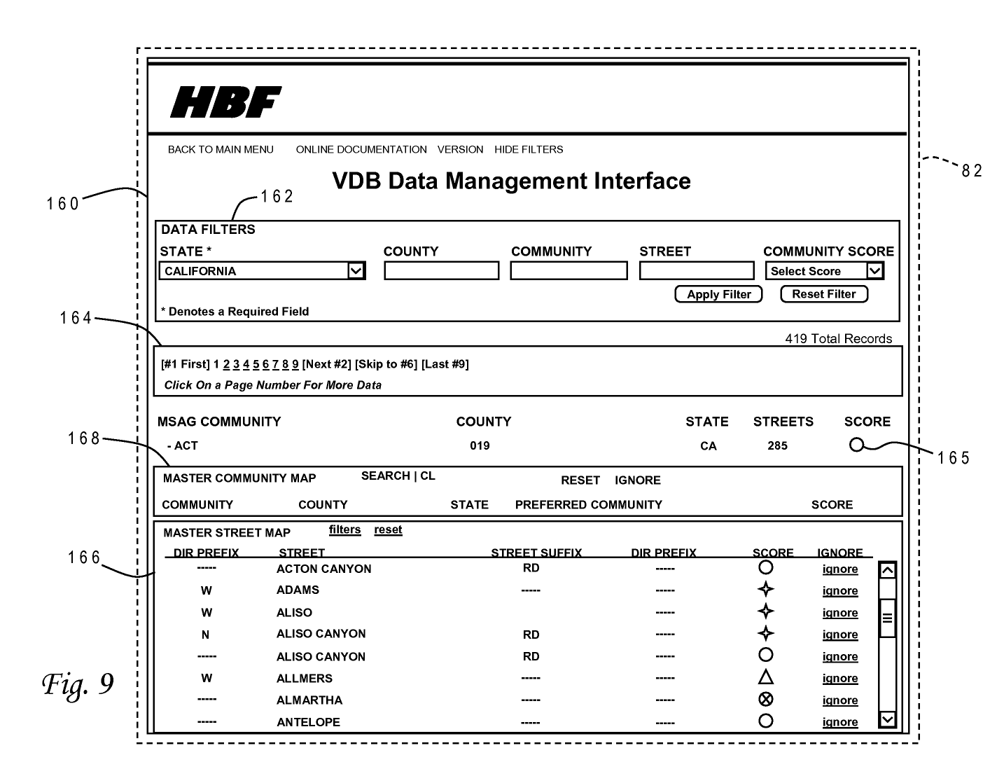

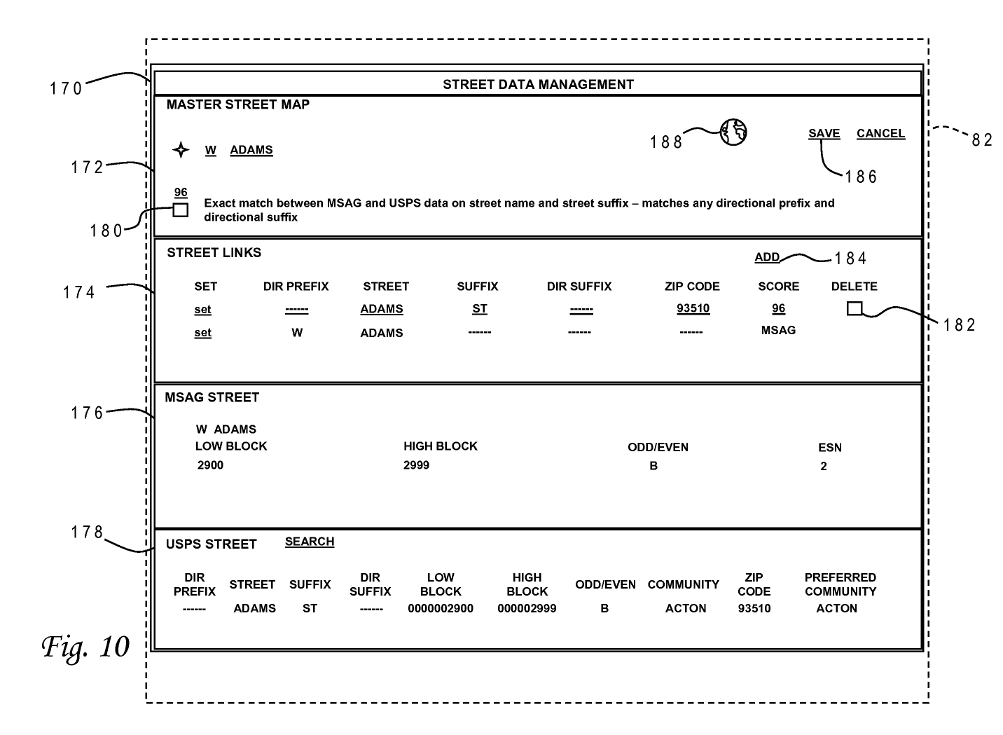

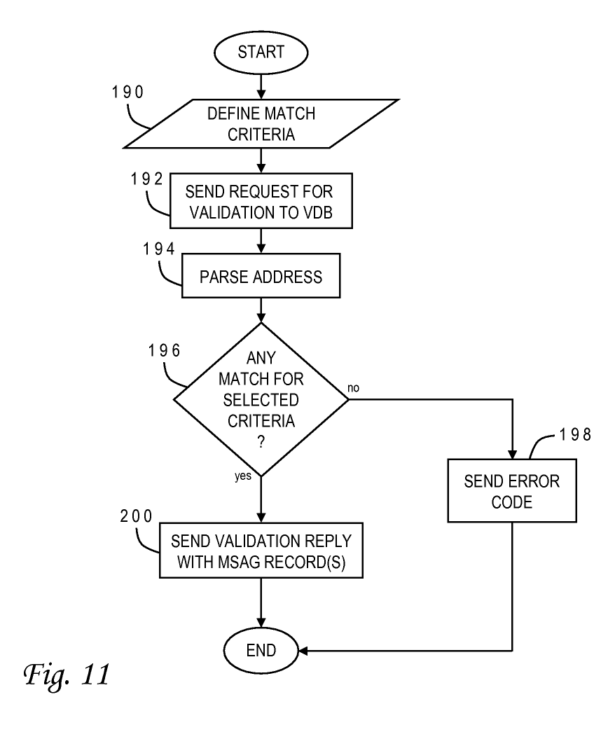

Exemplary interfaces for DMI 36 are depicted in FIGS. 9 and 10. These interfaces are displayed on monitor 82 of computer system 42, and have interactive fields which are selected or activated by pressing a button on pointing device 76 when the pointer on monitor 82 overlies the interactive field. FIG. 9 shows a user interface 160 for searching community or street records. User interface 160 includes a filter frame 162 having the various fields which may be used to establish the search criteria (state, county, community, street, and/or score). If the search results will take up several pages, a page finder frame 164 with hypertext links to other pages may be used to allow the agent to more quickly skip through the records. In this example the agent has selected to view the community of Acton (denoted “ACT” in the MSAG records). The green circle 165 for the score symbol of the MSAG community record indicates that this community is valid. Frame 166 presents the master street map records for this community. Eight streets are listed in this view, with various score category symbols. These scores represent the comparison of the MSAG street records to USPS records. If a record is found to be a duplicate or erroneous, an “ignore” button can be used to effectively remove the entry, in which case it is not further displayed or used. Community record search results can be similarly displayed in the master community map frame 168.

FIG. 10 shows a user interface 170 for editing street information and includes datasets from four of the tables in VDB 38. Data from the master street map table is shown in frame 172; data from the street links table is shown in frame 174; data from the MSAG street table is shown in frame 176; and data from the USPS street table is shown in frame 178. The MSAG and USPS data is provided for informational purposes only and is not editable. The USPS record in this example has been assigned a score of 96. This field, and others in master street map frame 172 and street links frame 174, may be selected by clicking on the text which causes a dialog box or child window to appear with an editable entry. Once the agent has edited the data and believes that it is all correct, the agent can manually change the score to 100, or click a check box 180 to automatically set the score to 100. A street link record can be removed by clicking a delete check box 182. Street links can also be added using the “ADD” button 184. Once the agent is finished editing the records, the “SAVE” button 186 is clicked and the modified data is stored in the VDB. A globe icon 188 provides a link to mapping software in case the agent wants to view a graphic street map of the area. A similar interface may be used to edit community records.

After the VDB data has been refined using DMI 36, VDB 38 is ready for use in address validation. FIG. 11 illustrates the logical flow for one implementation of an enhanced V7 communications protocol according to the present invention which allows the voice service provider (the VDB subscriber) to interrogate VDB 38. The subscriber-side of the V7M protocol is preferably provided as an XML client service that can be carried out at a remote subscriber office. As part of a new customer installation, the subscriber will associate a customer location with a new telephone number, and the voice service provider needs to ensure that the subscriber-provided location can be associated with a valid MSAG address range. The subscriber can choose to search for a matching VDB record using various criteria, such as search levels that provide different (independent) bases for matching. Search levels may be desired when search parameters might be inaccurate or incomplete. Table 4 describes the search scope for corresponding search levels in the preferred implementation. Combinations of search levels may be selected.

TABLE 4

| Search Level | Explanation |
|---|---|
| None | The search attempts to find only an exact match of the |
| | input location |
| Fuzzy | The search expands to include similar words (misspelled or |
| | typo) |
| Regular | The search attempts to match numeric components of a |
| Expression | street name |
| Soundex | The search attempts to match words that have similar |
| | pronunciation |

The V7M interrogation procedure accordingly begins with the subscriber defining the appropriate match criteria for the current query (190). Search levels can add significant processing time, so the first query preferably seeks an exact match (no search level selected) before more complex matches are attempted. The location is then transmitted with the match criteria over the Internet to VDB 38 with a request for validation (192). VDB 38 receives the request and parses the address to identify the location fields (194). VDB 38 automatically determines if any records match the location based on the selected criteria (196). This determination is accomplished by searching only those addresses that are considered valid by the VDB. If no match is found, VDB 38 sends an error code to the subscriber (198). If one or more matches are found, VDB 38 sends a validation reply with the corresponding MSAG records for each match (200). If the address provided by the subscriber can be matched to a single MSAG record, then validation is considered successful. Based on the information returned in the reply, the subscriber may want to correct the location entry and repeat the interrogation with a revised location.

The validation database system of the present invention accordingly provides an efficient and effective method for automatically constructing valid address records, and offers an intuitive interface which allows the VDB agent to easily correct errors from geographic reference data sources, or verify uncertain links. The enhanced interrogation protocol further gives the subscriber a more powerful tool in obtaining address validation for E-9-1-1 purposes.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. For example, other scoring systems may be used which do not rely on a 0-100 scale. It is therefore contemplated that such modifications can be made without departing from the spirit or scope of the present invention as defined in the appended claims.

What is claimed is:

1. An automated method of building a validation database, comprising:
receiving location records from a plurality of geographic reference data sources;
correlating first location records from a first one of the geographic reference data sources with second location records from a second one of the geographic reference data sources;
responsive to said correlating, establishing links to associate the first location records with the second location records; and
storing the first location records and the second location records with associated links in the validation database.

2. The method of claim 1 wherein:
the first and second location records include both community records and street records; and
the links include community links for the community records and street links for the street records.

3. The method of claim 1, further comprising assigning a score to each link representing a correlation confidence level.

4. The method of claim 3 wherein:
said correlating carries out multiple correlation algorithms; and
the score is based on a combination of results from the multiple correlation algorithms.

5. The method of claim 3 wherein a link is considered valid when it has a score representing at least a partial match for one of the first location records with one of the second location records.

6. A validation database comprising:
a computer-readable medium; and
a plurality of records stored in said computer-readable medium, a given record having data fields which include at least a first set of geographic reference data, a second set of geographic reference data, a set of master map data, a key, and link data associating the first set of geographic reference data with the second set of geographic reference data.

7. The validation database of claim 6 wherein the records include:
community records whose first set of geographic reference data includes a first community name, whose second set of geographic reference data includes a second community name, and whose link data includes a community link between the first and second community names; and
street records whose first set of geographic reference data includes a first street name, whose second set of geographic reference data includes a second street name, and whose link data includes a street link between the first and second street names.

8. The validation database of claim 7 wherein:
each community record further has a unique community key; and
each street record further has a unique community key and a unique street key.

9. The validation database of claim 6 wherein said link data includes a score representing a confidence level for a correlation between the first set of geographic reference data and the second set of geographic reference data.

10. The validation database of claim 9 wherein a record is considered valid when it has a score representing at least a partial match between the first set of geographic reference data and the second set of geographic reference data.

11. A user interface for managing a validation database residing in a storage device of a computer system, comprising:
a video monitor responsive to the computer system;
user input devices connected to said computer system, including a keyboard and a pointing device for activating interactive fields displayed on said video monitor; and
program instructions residing in said computer system for displaying on said video monitor (i) a search frame having a plurality of interactive fields to select criteria for searching geographic location records of the validation database, wherein the geographic location records include community records and street records, and the interactive fields include a community field, a street field, and one or more regional fields, and (ii) at least one results frame listing a subset of the geographic location records based on the search criteria, wherein a given record in the subset has an interactive field to allow management of the given record.

12. The user interface of claim 11 wherein said program instructions display two results frames on said video monitor, said results frames including a community results frame which lists any community records that match the search criteria, and a street results frame which lists any street records that match the search criteria.

13. The user interface of claim 11 wherein, when a user activates the interactive field for the given record in the results frame, said program instructions further display a location management window having editable master location information, first non-editable location information from a first geographic reference data source, second non-editable location information from a second geographic reference data source, and an editable link between the first non-editable location information and the second non-editable location information.

14. The user interface of claim 13 wherein the editable link includes an editable score representing a confidence level for a correlation between the first non-editable location information and the second non-editable location information.

15. The user interface of claim 14 wherein the editable link is a community link and, when the user edits the master location information, said program instructions invoke an update procedure to correlate the edited master location information with community records from the second geographic reference data source.

16. A method of interrogating a validation database, comprising:
transmitting a request for validation of a proposed address from a subscriber-side service to the validation database;
searching the validation database to find multiple records matching the proposed address; and
sending a validation reply from the validation database to the subscriber-side service with multiple geographic reference data corresponding to the multiple records.

17. The method of claim 16, further comprising parsing the proposed address by the validation database to identify multiple location fields before said searching.

18. The method of claim 16 wherein:
the validation database includes non-matching records, partially matching records, and exactly matching records; and
said searching searches both the partially matching records and the exactly matching records but not the non-matching records.

19. The method of claim 16, further comprising defining match criteria for the proposed address, wherein:
the match criteria is transmitted with the validation request; and
the multiple records are found based on the match criteria.

20. The method of claim 19 wherein the match criteria are defined by selecting one or more search levels, each search level providing a different basis for matching the proposed address to records of the validation database.

21. A system for managing address validation comprising:
a plurality of geographic reference data sources;
a validation database;
address correlation logic which automatically correlates first location records from a first one of said geographic reference data sources with second location records from a second one of said geographic reference data sources and establishes links in said validation database to associate the first location records with the second location records; and
a data management interface which allows a user to select criteria for searching records of said validation database at least by community or street, and displays a list of a subset of the validation database records based on the search criteria, wherein a given record in the subset has an interactive field to allow management of the given record.

22. The system of claim 21, further comprising a communications protocol which allows a subscriber to transmit a request for validation of a proposed address to said validation database, and receive a validation reply from said validation database wherein the reply includes multiple geographic reference data corresponding to multiple records of said validation database which match the proposed address.

23. The system of claim 21 wherein each link is assigned a score representing a confidence level for a correlation between a corresponding one of the first location records and a corresponding one of the second location records.

24. The system of claim 23 wherein:
said address correlation logic uses multiple correlation algorithms; and
the score is based on a combination of results from the multiple correlation algorithms.

25. The system of claim 23 wherein:
said data management interface allows the user to edit the score for the given record; and
when the user edits a link for a community record, said data management interface invokes an update procedure to correlate the community record with community records from the second geographic reference data source.
